(19) United States
(12) Patent Application Publication
(10) Pub. No.: US 2015/0003092 A1
(43) Pub. Date: Jan. 1, 2015

(54) LIGHTING DEVICE IN A MOTOR VEHICLE WITH A LIGHT CONDUCTOR ARRANGEMENT

(71) Applicant: Automotive Lighting Reutlingen GmbH, Reutlingen (DE)

(72) Inventor: Matthias Gebauer, Reutlingen (DE)

(21) Appl. No.: 14/283,362

(22) Filed: May 21, 2014

(30) Foreign Application Priority Data
Jun. 26, 2013 (DE) 10 2013 212 353.1

(51) Int. Cl. F21S 8/10

(52) U.S. Cl. CPC F21S 48/00
USPC 362/511

(57) ABSTRACT

A motor vehicle lighting device is presented with a light source and with an optical guide a coupling optics coupling and reshaping light of the light source, wherein the coupling optics has at least a deflecting reflector which reshapes the light being emitted from the light source into a solid angle. The coupling optics has a rotationally symmetrical light coupling surface around a rotational axis, said light coupling surface which has a convex curvature, the deflecting reflector is rotationally symmetrical to the rotational axis, and the light source is arranged on the rotational axis such that its main direction of emission lies on the rotational axis and points to the coupling optics.

### CROSS-REFERENCE TO RELATED APPLICATION

This application is based upon and claims priority to German Patent Application DE 102013212353.1 filed on Jun. 26, 2013.

### BACKGROUND OF THE INVENTION

1. Field of the Invention

The present invention relates to a motor vehicle lighting device.

2. Description of Related Art

Motor vehicle lighting devices known in the art typically include a light source and an optical guide. The optical guide has a first side, a second side opposite the first side, short sides lying between an edge of the first side and an edge of the second side and connecting the first side to the second side, as well as imaginary first and second planes and a coupling optics coupling and reshaping light of the light source. The coupling optics has at least a first reflector, which reshapes the light being emitted from the light source into a solid angle. The imaginary first and second planes are defined by the fact that they are perpendicular to one another and intersect, wherein the lines of intersection are defined by a light beam emanating from the deflection reflector. Such an optical guide is known for example from published German Patent Application No.: DE 199 25 263 A1. The known optical guide is plate-shaped and has extended boundary surfaces lying parallel to one another, as well as narrow boundary surfaces which join the plate-shaped boundary surfaces to one another. One of the small lateral surfaces serves as a light exit surface which, in one exemplary embodiment, extends over the entire width of the optical guide plate and therefore has an elongated, rectangular form.

In the case of the known optical guide, the coupling optics is a recess in the form of a round hole in the optical guide plate. The boundary surface of this recess serves as the light entry surface of the optical guide, and has a non-rotationally symmetrical shape. A light source is arranged in the interior of the recess. A short side of the optical guide lying opposite the light exit surface is designed as the first reflector, which deflects the incident light from the boundary surface of the recess to the light exit surface. The aforementioned first planes and second planes are not mentioned in DE 199 25 263, but are present there as imaginary planes.

In order to achieve a parallel light propagation in the optical guide, in a direction pointing to the light exit surface, the known subject matter provides that the second reflector opposite the strip-shaped light exit surface has parabolic contours on a plane parallel to the extended plate surfaces. The known subject matter further provides that the second reflector has a prism-like contour perpendicular to it, which deflects incident light twice such that the deflected light propagates in the direction to the light exit surface. The light source is arranged in the focal point of the parabolic contour. As a result, the second reflector directs the light incident on it, with a large opening angle therewith, as parallel light in the named planes on the strip-shaped light exit surface opposite the reflector.

One disadvantage of this optical guide is that radial light of the light source emitted directly into the half space facing the light exit surface does not meet the first reflector and, therefore, is not aligned in parallel. However, for use with lighting devices of motor vehicles (such as headlight functions or signal light functions), a light exit surface illuminated from the inside of the optical guide with the most parallel light possible and shining as homogenously as possible (uniformly bright) is desired. Such light has the advantage that it can be distributed especially easily in government-mandated light distributions by scattering optics in the light exit surface, and/or by subsequent optics in the light issuing from the light exit surface in the beam projection. In addition, for aesthetic reasons, it is desirable for the light guide to have a strip-shaped light exit surface, with a great ratio of the length of the light exit surface to its width, and which meets the requirements of homogeneity and parallelism discussed above.

### SUMMARY OF THE INVENTION

The present invention overcomes the disadvantages in the related art in a motor vehicle lighting device with a light source and an optical guide. The optical guide has a first side, a second side opposite the first side, short sides lying between an edge of the first side and an edge of the second side and connecting the first side to the second side, imaginary first and second planes, and a coupling optics coupling and reshaping light of the light source. The coupling optics has at least a deflecting reflector which reshapes the light being emitted from the light source into a solid angle. The imaginary first planes and second planes are defined by the fact that they are perpendicular to one another and intersect, wherein the lines of intersection are defined by a light beam emanating from the deflection reflector. The coupling optics has a rotationally symmetrical light coupling surface around a rotational axis. The light coupling surface has a convex curvature. The deflecting reflector is rotationally symmetrical to the rotational axis. The light source is arranged on the rotational axis such that its main direction of emission lies on the rotational axis and points to the coupling optics.

In one embodiment, the convex curvature in radial direction is axisymmetrical to an imaginary straight line which intersects the radial direction and which intersects the rotational axis at the sight of the light source.

Further, the convex curvature, the index of refraction of the coupling optics, and the arrangement of the light source may be coordinated so that the light beams coupled via the convex curved light coupling surface run parallel to the straight lines. The first reflector may be an indentation in the first side of the optical guide and may have the shape of a truncated cone which tapers in the direction of the second side of the optical guide. Advantageously, the cross-section profile is curved such and a light emitting diode is correspondingly arranged such that the light coupled over the cross section is oriented in parallel and is parallel to the straight line. The coupling surface may be an indentation in a projection protruding from the second side. In one embodiment, the projection has the shape of a truncated cone that propagates in the direction of the second side.

In one embodiment, the coupling surface is an indentation in the second side and has a first subarea with a convex curvature in radial direction which is axisymmetric to an imaginary straight line which intersects the radial direction and which intersects the rotational axis at the site of the light source, and has a second subarea with a convex curvature in radial direction which is axisymmetric to the rotational axis, and that the first reflector has a first region that is in the shape of a truncated cone and is illuminated over the first subarea, and has a second region that is conical and is illuminated by the light that is coupled over the second subarea.

It is also advantageous if a thickness of the optical guide outside of the projection or outside of the convex curved light coupling surface is not less than the double depth of the deflection reflector. Further, the coupling optics may include a roof edge reflector. In one embodiment, a thickness of the optical guide outside the projection or outside of the convex curved light coupling surface is not less than the depth of the deflection reflector. The coupling optics and a transport and deflecting optics may be formed as separate components that are joined together to an optical guide. Further, the coupling optics and a transport and deflecting optics may be components of a single-piece contiguous component. In one embodiment, the decoupling optics has a light exit surface and is set up to align in parallel light beams radially directed away from the rotational axis over an angular width of 180° and direct them uniformly distributed onto the light exit surface. Further, the decoupling optics may have a light exit surface and may be set up to align in parallel light beams radially directed away from the rotational axis over an angular width of 360° and direct them uniformly distributed onto the light exit surface.

Other objects, features and advantages of the present invention will be readily appreciated as the same becomes better understood after reading the subsequent description taken in connection with the accompanying drawings

### BRIEF DESCRIPTION OF THE DRAWINGS

Exemplary embodiments of the invention are presented in the drawings and are described in greater detail in the subsequent description. The figures show the following, in schematic form:

FIG. 1 shows one embodiment of an inventive lighting device in a longitudinal section.

FIG. 2 shows an embodiment of an optical guide having features of the invention.

FIGS. 3A-3E show different views of one embodiment of a coupling module implemented as a separate component.

FIGS. 4A-4D show different views of one embodiment of a coupling module implemented as a separate component.

FIG. 5 shows one embodiment of a transport and deflecting optics that form a holding fixture for the coupling optics of FIGS. 3A-3E.

FIG. 6 shows one embodiment of an optical guide in a top view.

FIG. 7 shows an assembly including an optical guide, light emitting diodes, a printed circuit board, and a cooling body.

FIG. 8 shows one embodiment of an arrangement including a light source and an optical guide.

FIG. 9 shows an arrangement including a printed circuit board with one or more LEDs, a coupling optics, and a transport and deflecting optics.

FIG. 10 shows one embodiment of an optical guide whose coupling optics has a first light coupling surface and a second light coupling surface.

FIG. 11 shows one embodiment of an optical guide with multiple arc-shaped curved light exit surfaces.

FIGS. 12A-12B show embodiments of the coupling optics with associated transport and deflecting optics.

### DETAILED DESCRIPTION OF THE INVENTION

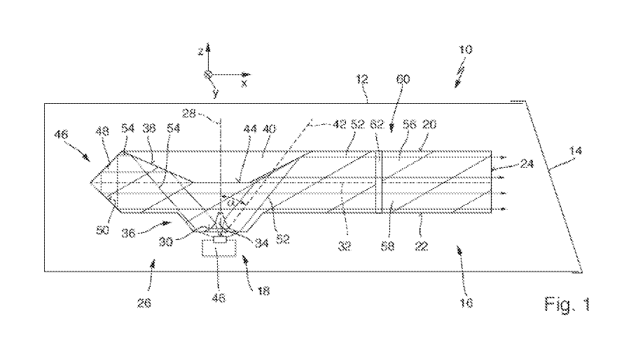

Referring now to the figures, where like numerals are used to designate like structure, FIG. 1 shows an exemplary embodiment off an inventive motor vehicle lighting device 10. The lighting device 10 has a housing 12 whose light exit opening is covered by a transparent cover disk 14. An optical guide 16 and a light source 18 are arranged in the housing 12. For reasons of space, the optical guide 16 is shown abridged in x-direction. The x-direction corresponds here to a main direction of emission. In the event of an appropriate usage of the lighting device in a street motor vehicle, this is, for example, the forward direction of travel or the reverse direction of travel. The y-direction is parallel to a horizontal axis and the z-direction is parallel to a vertical axis of the motor vehicle. The light source 38 is arranged on a carrier element 46 serving the purpose of electrical contact, the carrier element also includes a cooling body.

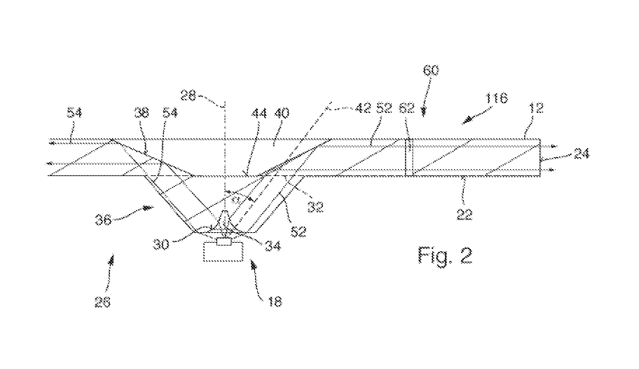

The light source 38 may be a semi-conductor light source in the form of a Light Emitting Diode (LED). The LED has a plane light exit surface. Such semi-conductor sources can be considered Lambertian radiators by approximation that emit their light over an angular region of 90 degrees to a perpendicular of the LED light exit surface in a half space with solid angle 2II. A main direction of emission of the light source 38 points upward in FIG. 2 and coincides with a rotational axis 28 as explained in greater detail below.

The optical guide has a first side 20, a second side 22 opposite the first side 20, and a short side lying between an edge of the first side 20 and an edge of the second side 20 and connecting the first side to the second side. The first side 20 and the second side 22 lie parallel to the x-y plane of the specified coordinate system here. However, it is not absolutely necessary for the invention that the first side be parallel to the second side. The dimensions of the first side 20 and the second side 14 are large relative to the width of the small side, which corresponds to the distance of the first side to the second side. This large ratio shapes the appearance of the optical guide 10 as a plate-shaped part. The ratio is advantageously greater than five.

A region of the small side 20 lying in x-axis direction with a perpendicular is embodied as light exit surface 24. The expanse of the light exit surface 24 in y-axis direction is many times greater than its expanse in the direction of the z-axis, as a result of which a strip-shaped form of the light exit surface 24 arises in the x-z plane. The optical guide 16 has a coupling optics 26. The coupling optics 26 has a rotation-symmetrical light coupling surface 30 around the rotational axis 28, which, in planes in which the rotational axis 28 and a radial direction 32 proceeding rectangular-radially from the rotational axis 28 has a curvature appearing convex from outside of the coupling optics 26. Such planes constitute second planes within the meaning of this application, and can be referred to as radial planes because of their radial alignment. The drawing plane of FIG. 1 corresponds to such a radial plane. The coupling surface 30 here is a boundary surface of an indentation 34 in a projection 36 protruding from the second side 22. The projection 36 has the form of a truncated cone on the outside which propagates in the direction of the second side.

The coupling optics 26 also has a first reflector 38 arranged rotation-symmetrically to the rotational axis 28. The first reflector 38 is the boundary surface of an indentation 40 in the first side 20 of the optical guide. The indentation has the shape of a truncated cone that tapers in the direction of the second side 22 of the optical guide. The boundary surface of the indentation may be shaped such that the light from a light source lying on the rotational axis shining on it undergoes an internal total reflection. As an alternative or supplement, the reflecting surface of the first reflector 32 is mirrored, for example by a metal layer applied to it. This also applies for all reflecting surfaces mentioned in this application. However, it is advantageous to develop these surfaces as internal totally reflecting boundary surfaces, to the extent to which the angular relationships permit, because fewer losses occur in the case of internal total reflections than with mirrored boundary surfaces, which promotes high efficiency. Embodiments without mirroring layers to be applied are also desirable, because coating processes are expensive and time-consuming.

The light source 18 is arranged on the rotational axis 28 such that its main direction of emission lies on the rotational axis 28 and points to the coupling optics 26. The convex curvature of the light entry surface 30 of the coupling optics 26 lying in the radial planes is axisymmetric to an imaginary straight line 42 which intersects the radial direction 32 and which intersects the rotational axis 28 at the site of the light source 18, in particular in the light exit surface of the light source. Such a straight line 42 lies in each radial plane, so that all such radial planes lie on the surface of an imaginary cone whose tip lies in the light exit surface of the light source 18. The opening angle of the light beam proceeding from the light source is reduced by the refraction on this light entry surface 30 in the second planes. The degree of curvature of the convex curvature, the index of refraction of the transparent material of the coupling optics 26, and the arrangement of the light source 18 are coordinated to one another such that light beams coupled over the convex curved light entry surface run parallel to the straight line 42 within every second plane.

Light goes from the light source 18 to a solid angle in whose center the axis 28 lies. This light falls at least partially on the first reflector 38 and is reflected from there in such a way that the reflected light beams in first planes, which lie parallel to the x-y plane in FIG. 1, are deflected. Directional components of the light beams lying radial to the axis 28 are preserved at first due to the rotational symmetry of the first reflector 38 to the axis 28. The light source 18 thus radiates from below towards the indentation 40 constituting the first reflector 38. The indentation 40 does not completely penetrate the optical guide 10. Its depth, and the distance of its deepest places 44 from the first side 20, is roughly equal to half of the plate width, wherein the plate width corresponds to the distance of the first side 20 to the second side 22 measured outside the indentation 40 and outside of the projection 36. The axis 28 divides the optical guide 16 in x-direction into a front region, which faces the light exit surface 24 and lies between the axis 28 and its light exit surface 24, and a rear region, which is limited here by a second reflector 46 and which thus lies between the second reflector 46 and the axis 28. The second reflector 47 is designed here as a reverse reflector. The reverse reflector has a first reflector surface 48 and a second reflector surface 50, which are inclined to one another such that a light beam shining on one of the two reflector surfaces is first reflected to the other reflector surface. At this other reflector surface, the light beam is deflected once more in the reflection, so that its direction is opposed to the direction from which the light beam first came in on one of the two reflector surfaces.

Due to the two roof-like reflector surfaces 48 and 50 inclined toward one another, the second reflector is also referred to as a roof edge reflector. In first planes, thus for example in a plane perpendicular to the drawing plane of FIG. 2 in which the radial direction 32 lies, the second reflector 46 has a semicircular shape which, viewed over the semicircle, is concentric to the circular base of the first reflector 38 and is thus coaxial to the axis 28. Light 52 that shines on an area of the first reflector 38 lying in the front region is reflected on the area such that it propagates further in the front region. Light 54 that shines on an area of the first reflector 38 lying in the rear region is deflected on the area first to the second reflector 46. The contours of the first reflector 38 run in a straight line in each radial plane. Therefore, in such a radial plane light beams coming in parallel to one another are converted through the reflections to beams going out parallel to one another.

Along with the second plane lying in the drawing plane, a plurality of other second planes also exist. All second planes are generated on the first reflector through the axis 28 and a light beam 52 or 54 after its reflection. The reflecting light beams 52 and 54 point radially from the axis 28 of the coupling optics 26, or may at least have a radial component. The reflecting light beams 52 or 54 define a line of intersection which the second plane has in common with the first plane. The first plane is perpendicular to the second plane. In principle, it is conceivable that each light beam 52 and 54 reflecting from the first reflector 38 includes a first plane and a second plane perpendicular to the first plane.

A center plane, which contains the radial directions 32 and is perpendicular to the rotational axis 28, divides the optical guide 10 into an upper half 56, in which the indentation 40 or at least the greater part of the indentation 40 lies, and a lower half 58 into which at best only the deepest places of the indentation 40 project. The lower half 58 faces the light source 18 and, thus, lies between the light source 18 and the first half 56 and, thus, between the light source 18 and the indentation 40. The light beams reflected on the surface of the first reflector lying in the rear region shine on the first reflector surface 48 of the second reflector 46. The first reflector surface 48 is, thus, inclined toward the center plane of the optical guide 10 such that light beams meeting there are deflected in the direction of the second reflector surface 50. On the second reflector surface 50, the light beams 54 deflected on the first reflector surface 48 are reflected in the direction of the rotational axis 28 and, thus, in the direction of the front region of the optical guide 16. Due to the semicircular geometry of the second reflector 46 in the first planes, the second reflector 46 reflects the radial incident light from the first reflector 38 back in the radial direction opposite the incident direction. In operation, the reflected light in the second plane is deflected twice in succession at a right angle to its respective incident direction. Moreover, light propagated first in the upper half 56 is deflected to the lower half 58. Because the first reflector 38 does not completely penetrate the lower half 58, the light below the first reflector 38 propagates through the lower half 58 of the optical guide 16 into the front region of the optical guide 16 and, in operation, is not disturbed by the first reflector.

The frustoconical shape of the first reflector 38 and the second reflector 46 designed as a reverse reflector, and causes the light beams 52 that go out from the first reflector 38 into the front region of the optical guide turned away from the second reflector 46 to propagate above the center plane of the optical guide (see FIG. 1). The light beams 54, which go out from the first reflector 38 in a rear region of the optical guide facing the second reflector 46 undergo a double reflection at the reverse reflector 46, which causes a reversal of direction and a vertical displacement of the light beams 54. Hence, the light beams 54 propagate below the center plane (see FIG. 1). In conjunction with a parallel orientation of the light beams within the second planes then, the advantage arises of a uniform illumination of the light exit surface 24 over its expanse along the z-axis.

A thickness of the optical guide is not less than the double depth of the reverse reflector here outside of the projection 36 and the indentation 40. The coupling optics has a roof edge reflector. The first reflector 38 is rotationally symmetrical. As a consequence, with respect to the axis 28, radial directional components of the light from the light source 18 are not changed in the reflection on the first reflector and hence are preserved. The light is therefore not parallel in the first planes, but rather radially oriented. The optical guide 16 has additional structures 60 which are set up to deflect the propagating light in the optical guide 16 in the first planes such that the light exit surface 24 of the optical guide 16 from its inside is also illuminated along the first planes uniformly bright with by and large parallel oriented light. As shown in FIG. 1, this is in particular the case when the light in planes parallel to the x-y plane is oriented parallel and is uniformly distributed along the y-direction. With such light, a government-mandated light distribution can be easily produced which, for example, extends over a horizontal angular width of +/−20° and a vertical angular width of +/−10°. In the case of the subject matter of FIG. 1, these structures 60 have an air lens 62 which bundles the propagating light in the first planes, first radially to the axis 28 and, in particular, orients it parallel in operation. The functionality of the structures 60 will be described in detail further below with the help of additional figures.

The reshaping of the parallel light into a government-mandated light distribution may occur, for example, with cushion-shaped or cylinder surface section shaped scattering optics in the light exit surface of the optical guide. FIG. 2 shows one embodiment of an optical guide 116 having features of the invention. The optical guide 116 differs from the optical guide 16 of FIG. 1, in particular in that it does not have the second reflector 46 implemented as a roof edge reflector and acting as a reverse reflector. With respect to its dimensions, a thickness of the optical guide 116 outside of the projection 36 and outside of the indentation 40 is not less than the depth of the first reflector 38 and thus is not less than the depth of the indentation 40. In the case of this embodiment, the deflection of the light that goes from the first reflector to the half space averted from the light exit surface 24, takes place in the half space facing the light exit surface 24 not by a roof edge reflector, but rather by deflecting structures, as will be described further below with respect to FIG. 6. Here too, the optical guide 116 has structures 60 set up to deflect the light propagating in the optical guide 116, light which first propagates radially with respect to the axis 28 after the reflection on the first reflector 38 in such a way that the light exit surface 24 of the optical guide 116 is illuminated from its inside uniformly brightly with by and large parallel oriented light.

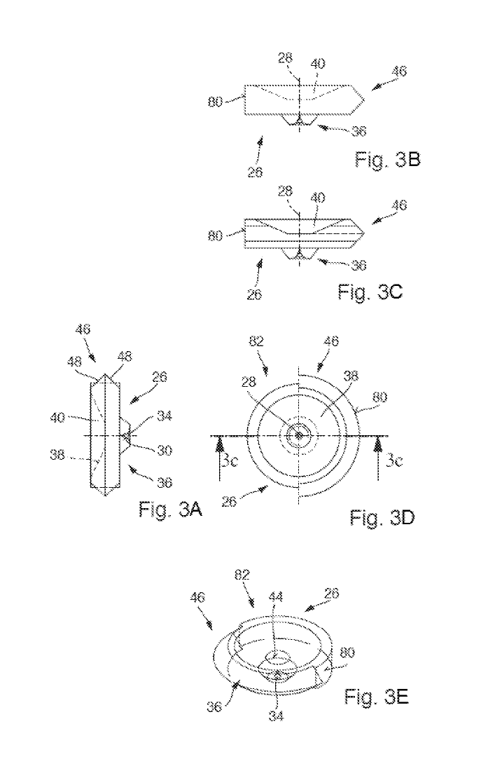

FIGS. 3A-3E show an embodiment of a coupling module 26 implemented as a separate component, wherein the optical guide, be it optical guide 16 or optical guide 116 or another embodiment of an optical guide which has the described properties, along with the coupling optics 26, also has a transport and deflecting optics complementary to the coupling optics, the transport and deflecting optics supplementing the coupling optics for the described optical guide. Such a transport and deflecting optics will be described in greater detail further below. FIG. 3A shows a view of the coupling optics presented to a viewer on the x-axis on the left in FIG. 1 and, therefore, looking head-on at the roof edge reflector 46. FIG. 3B shows a lateral view of the coupling module with a light exit surface 80, over which light passes from the coupling module to the rest of the optical guide. FIG. 3C shows a section along the line 3c-3c in FIG. 3D, which shows a top view. The plane of the top view may be parallel to the aforementioned first planes. FIG. 3E shows a perspective view of the coupling optics 26. The coupling optics is delimited in sections here in the shape of a circle. The roof edge reflector 46 extends over a semicircle. The complementary semicircle 82 is delimited by a semi-cylinder surface shaped light exit surface 80 of the coupling optics. The center of both semicircles lies on the axis 28. The radius of the outer boundary of the roof edge may be greater than the radius of the semi-cylinder surface 82. As a result, the part of the roof edge projecting above the semi-cylinder surface can be used as a stop surface, which improves the positioning accuracy in the fitting together of the component. The subject matter of FIGS. 3A-3E is in particular compatible with the subject matter of FIG. 1, and can be implemented both as a separate component of the optical guide 16 as well as also as a single piece contiguous component of the optical guide 16 firmly bonded to the rest of the optical guide 16.

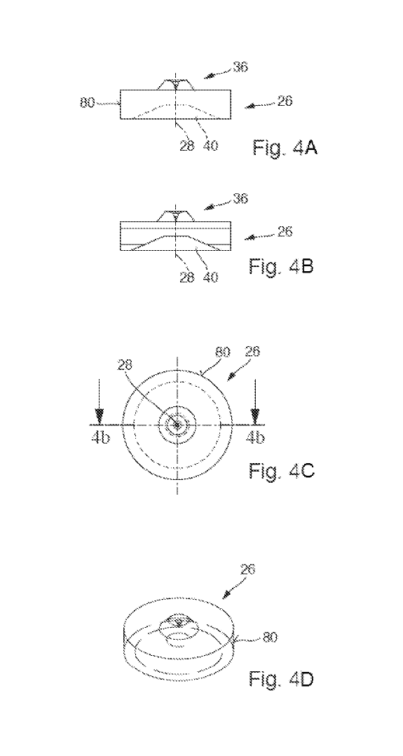

FIGS. 4A-4D show an alternative embodiment of a coupling module 26 that is likewise implemented as a separate component. FIG. 4A shows a lateral view of the rotationally symmetrical coupling module 26 around the axis 28 with a light exit surface 80, via which the light passes from the coupling module to the rest of the optical guide. FIG. 4B shows a section along the line 4b-4b in FIG. 4C, which shows a top view. The plane of the top view may be parallel to the aforementioned first planes. FIG. 4D shows a perspective view of the coupling optics 26. The coupling optics 26 is rotationally symmetrically delimited here in the shape of a circle. The light exit surface 80 has the shape of a cylinder surface. The center of the circular shape lies on the axis 28. The subject matter of FIGS. 4A-4D is in particular compatible with the subject matter of FIG. 2 and can be implemented both as a separate component of the optical guide 116 as well as also as a single piece firmly bonded component of the optical guide 116 with the rest of the optical guide 116.

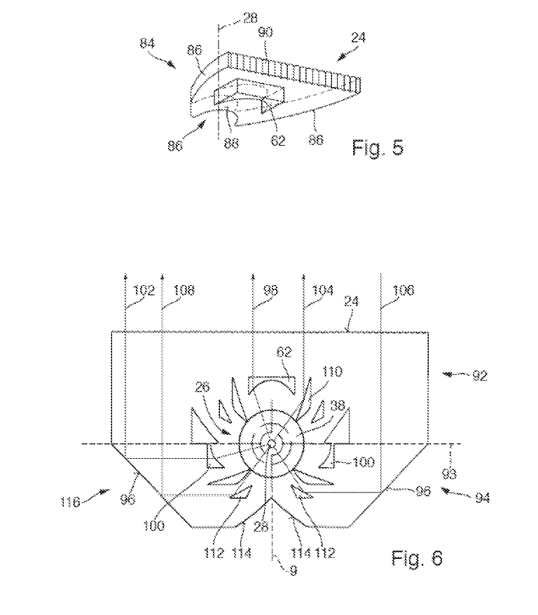

FIG. 5 shows an embodiment of a transport and deflecting optics 84 which, in particular, is compatible with the coupling optics 26 of FIGS. 3A-3E and which, together with the coupling optics, forms an optical guide 16 as in FIG. 1. The transport and deflecting optics 84 has a holding fixture 86 which is set up for receiving a coupling optics 26. Via the light exit surface 80 of the coupling optics 26, exiting light passes via the light entry surface 88 that is in the shape of a semi-cylinder here to the transport and deflecting optics 84. The surfaces 80 and 88 advantageously adjoin, in operation. The transport and deflecting optics 30 have structures set up to deflect light propagating in the transport and deflecting optics 84 in such a way that the light exit surface 22 of the optical guide 10 is illuminated from its inside uniformly brightly with by and large parallel oriented light. With such light, a government-mandated light distribution can be easily produced which, for example, extends over a horizontal angular width of +/−20° and a vertical angular width of +/−10°. In the case of the subject matter of FIG. 5, these structures are formed by a central air lens 62 and an outer reflector which has parabolic outside sections 86. The central air lens may be shaped in such a way that it orients the radial outgoing light parallel and directs it to the light exit surface 24. The air lens may have a concave-plane shape from the view of the incident light there. The parabolic sections 86 may be shaped such that their focal point lies on the axis 28 upon which the light source is also located. Then, the parabolic sections direct the radial light going out from the axis 28 on them and incident on the sections 86 likewise as a pencil of parallel light on the light exit surface 24. The reshaping of the parallel light into a government-mandated light distribution occurs, for example, with scattering optics 90 in the light exit surface 24 of the transport and deflecting optics 84 or of the light exit surface of the optical guide. The transport and deflecting optics 84 of FIG. 5 can be used with the coupling optics of FIGS. 3A-3E and 4A-4D. Due to the lacking deflection which takes place, in the case of the coupling optics according to FIGS. 3A-3E through the roof edge, in the event of a combination of the subject matters of FIGS. 4A-5 however, only half the efficiency results.

FIG. 6 shows an embodiment of an optical guide 116 which, in the case of the use of the coupling optics of FIG. 5, has an equally high efficiency as a combination of the subject matters of FIGS. 3A-3E and 5. FIG. 6 shows, in particular, a top view of such an optical guide. Here too, it the coupling optics can be implemented both as a separate component and as well as also as firmly bonded component of the optical guide. The optical guide has a front region 92 and a rear region 94. The boundary 93 runs between the front region 92 and the rear region 94 and runs through the axis 28. The front region lies in the half space, wherein light reflected on the rotationally symmetrical first reflector 38, which propagates in this half space, has a directional component pointing to the light exit surface 24. This is not the case with the rear region, where the propagating light has a directional component pointing away from the light exit surface. As structures that are set up to deflect propagating light in the optical guide 116, or in its part serving as transport and deflecting optics in such a way that the light exit surface 24 of the optical guide 116 is illuminated from its inside uniformly brightly with by and large parallel oriented light, the subject matter has two different types of recesses and two different types of outer reflectors. First recesses 62, 100 depict air lenses that deflect the light by refraction. Second recesses 110, 112 depict reflectors lying inside the optical guide, in particular TIR reflectors. First outer reflectors 96 only deflect incident light without changing the angle lying between the individual beams. The first recesses include a central air lens 62, which is arranged in the front region 92 and which directs the radial incident light from the axis 28 parallel and to the front, as well as decentralized arranged air lenses 100, which guide radial incident light 102 from the axis 28 parallel and to the side on the first outer reflectors 96.

The first outer reflectors 96 are arranged such that they deflect the incident light from the decentralized air lenses to the front. The second recesses 110, 112 have parabolic surfaces facing the radial incident light 104, 106 from the axis 28, with the parabolic surfaces orienting the incident light parallel. Second recesses 110 in the front region direct the parallel light 104 to the front. Second recesses 112 in the rear region guide the parallel light 106, 108 to the side on the first outer reflectors 96, which deflect the light to the front. Second outer reflectors 114 are parabolic and direct the radial incident light on them from the direction of the axis 28 parallel and to the side on the first outer reflectors 96, which likewise deflect this light to the front. It should be recognized that the second outer reflectors could be implemented as inner reflectors. The air lenses may have a concave-plane shape from the view of the incident light there. The parabolic sections may be shaped in such a way that their focal point lies on the axis 28 upon which the light source 18 is also located. On the light exit surface 24, advantageously cushion-shaped and or cylinder surface section shaped scattering optics are arranged, which expand the parallel light to a government-mandated light distribution.

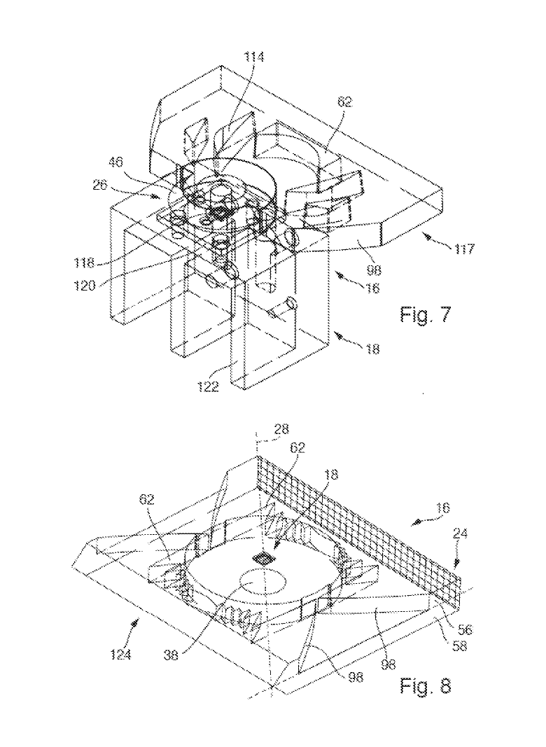

FIG. 7 shows an assembly of an optical guide, which includes a coupling optics 26 with roof edge reflector 46, a transport and deflecting optics 117 with outer reflector 98, air lens 62 and inner reflectors 114 for parallelization and a light source with one or more light emitting diodes 118 of the same color or variously colored, a circuit board 120 bearing the light emitting diode(s), and a cooling body 122.

FIG. 8 shows one embodiment of an arrangement of a light source 18 and an optical guide 16, for which the parallelization takes place in the first planes with air lenses 62 and parabolic outer reflectors 98. The air lenses here have a Fresnel structure. The focal point of the parabolas lies on the rotational axis 28 of the first reflector 38. In the case of this optical guide, the coupling optics is a rotationally symmetrical, in particular cylindrical coupling optics, as depicted for example in FIGS. 4A-4D. The optical guide has a light exit surface 24 with formed scattering optics which may be in the form of a cushion, or which have the form of parts of cylinder surfaces. A straight roof edge reflector 124 is arranged on the side opposite the light exit surface. Similar to the optical guide 16 of FIG. 1, the optical guide 16 is divided into an upper half 56 and a lower half 58. The parallelization of the light in the first planes takes place here solely in the upper half 56. The light shining in the upper half on the roof edge reflector is parallelized in the first planes and the second planes and is reversed in its direction by the roof edge reflector vertically displaced such that it runs in the lower half 58 below the first reflector 38 to the light exit surface 24.

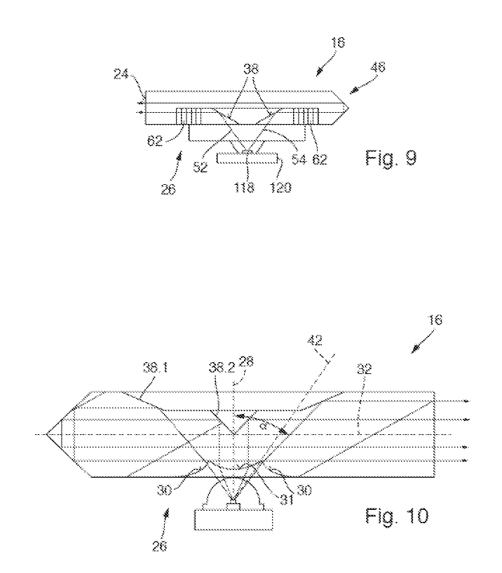

FIG. 9 shows an arrangement of a circuit board 120 with one or more LEDs 118, a rotationally symmetrical coupling optics 26, and a transport and deflecting optics, as the optical guide 16 presented in FIG. 8 has. As shown there, the transport and deflecting optics, which together with the coupling optics forms the optical guide 16, has supplementary Fresnel air lenses and outer reflectors. The light going out from the first reflector 38 in the rear region is first parallelized via a Fresnel air lens in the first planes and then deflected to the front by the roof edge reflector 46, wherein above the reflector 38 said light reaches the light exit surface 24 past the reflector 38. The light 52 going out from the first reflector 38 in the front region is first parallelized via a Fresnel air lens 62 in the first planes and subsequently reaches the light exit surface 24 without further deflection.

FIG. 10 shows an embodiment of an optical guide 16 whose coupling optics 26 have a rotationally symmetrical first light coupling surface 30 and a second light coupling surface 31 around a rotational axis 28. The first light coupling surface 30 has a convex curvature in the radial planes. The convex curvature of the first light entry surface 30 of the coupling optics 26 lying in the radial planes is axisymmetric to an imaginary straight line 42, which intersects the radial direction 32 and which intersects the rotational axis 28 at the site of the light source 18, in particular in the light exit surface of the light source. In this respect, the coupling optics of the embodiment of FIG. 10 does not differ from the coupling optics of the embodiments described with reference to FIGS. 1-4D. Differences to this coupling optics arise in the case of the subject matter of FIG. 10 in that the second light coupling surface presents a boundary surface of a central lens that is rotationally symmetrical to the axis 28 and whose curvature is axisymmetric to the axis 28. In the case of this embodiment, along with the rotated and tilted lens profile, which includes the first light entry surface 30 of the coupling optics, a central lens is also used. In each radial plane, the edge, via which light enters into the coupling optics, then has three regions. Each region orients the light coming in above it parallel to its axial symmetry axis. The pencils entering via the various regions are not parallel to one another. In the case of this embodiment, the first reflector then includes two regions. A first region 38.1 has the shape of a surface of a truncated cone that is rotationally axisymmetric to the axis 28 and is arranged such that it deflects the incoming light via the lens profile 30 to first planes. A second region 38.2 has the shape of a conical surface and is likewise rotationally axisymmetric to the axis 28. This second region 38.2 of the first reflector 38 also deflects the incident light from the light source to the first planes. Due to the differing angles to the axis 28, with which the light pencils coming in from the various regions 30, 31 of the light entry surface propagate in the coupling optics 26, the cone angle (angle in the tip of the cone) needs to be different in order to deflect the light to first planes that are parallel to one another. The advantage of this embodiment as opposed to the embodiments of FIGS. 1-2 is that the coupling optics 26 (and, thus, the optical guide 16) can be flatter overall, which saves installation space. The central lens namely captures the paraxial part of the light going out from the light exit surface of the light source, the paraxial part being captured in the case of the subject matter of FIGS. 1-2 from the height requiring steep paraxial regions of the profile 30. Because the central lens only slightly deflects the light, it can be designed very flat. In the case of the subject matter of FIG. 10, therefore, it is possible to omit the projection 36.

FIG. 11 shows an embodiment of an optical guide 216 in which the light exit surface 24 is designed as u-shaped. The view presents itself to a viewer in the direction of emission, who is some distance away from the direction of emission, and is looking at the light exit surface. The optical guide 216 has several coupling optics 26. The optical guide 226 could be implemented as optical guides 16 or 116 arranged next to one another primarily in y-direction, wherein some of the optical guides are curved around the x-axis in order to produce the required arcs. Each of the coupling optics 26 has a light source assigned to it. The optical guide 216 has support structures 218 that are suitable and arranged for the purpose of supporting the optical guide in the housing. The coupling optics 26 are distributed along the light exit surface 22 of the optical guide so that a uniformly homogeneous illumination of the complicated shaped strip-like light exit surface 22 is guaranteed practically parallel light.

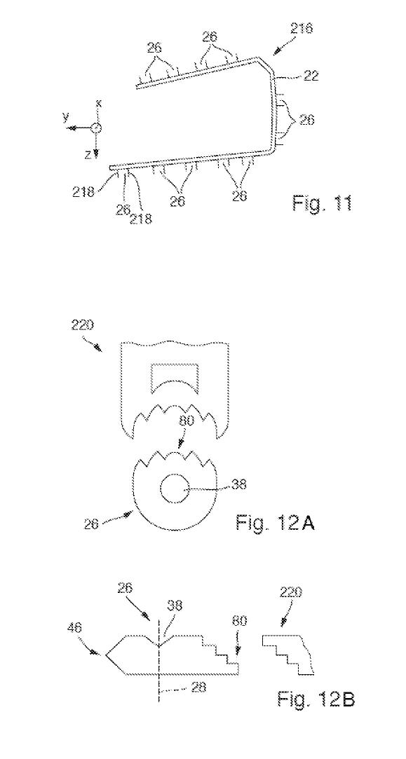

FIG. 12A shows an embodiment of the coupling optics 26 and an associated transport and deflecting optics 220 in top view. The light exit surface 80 of the coupling optics is divided into a plurality of individual surfaces here that are arranged and shaped such that the directions of propagation of the light lying in the first planes can be specifically modified by penetration through an individual surface. As a result of this, it is possible to specifically change an opening angle of the directions of propagation of the light in the first planes already in the transition of the coupling optics 26 to the transport and deflecting optics 220. The transport and deflecting optics 220 is designed to be less expensive, in particular, if necessary the structures 60 for parallelization in the first planes can be omitted. In another embodiment, which arises in the case of the subject matter of FIG. 12A through a combination with a light entry surface of the transport and deflecting optics 220 shaped as a negative of the light exit surface 80 of the coupling optics 26, the resulting gearings serve as form fitting elements for precise positioning and support of the coupling optics in the transport and deflecting optics. FIG. 12B shows a further embodiment of the coupling optics 26 in a sectional representation parallel to the x-z plane. In the presented embodiment, the light decoupling surface 80 of the coupling optics 26 is divided into a plurality of individual surfaces. The individual surfaces are arranged on top of one another in operation. The stepped arrangement of the individual surfaces makes possible a positive fit of the coupling optics 24 in z-axis direction to the transport and deflecting optics 220.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

What is claimed is:

1. A motor vehicle lighting device comprising: a light source and an optical guide which has a first side, a second side opposite the first side, short sides lying between an edge of the first side and an edge of the second side and connecting the first side to the second side, imaginary first and second planes, and a coupling optics coupling and reshaping light of the light source, wherein the coupling optics has at least a deflecting reflector which reshapes the light emitted from the light source into a solid angle, and wherein the imaginary first planes and second planes are defined perpendicular to one another and intersect, wherein the lines of intersection are defined by a light beam emanating from the deflection reflector, and the coupling optics has a rotationally symmetrical light coupling surface around a rotational axis, said light coupling surface has a convex curvature, the deflecting reflector is rotationally symmetrical to the rotational axis, and the light source is arranged on the rotational axis such that its main direction of emission lies on the rotational axis and points to the coupling optics.

2. The lighting device as set forth in claim 1, wherein the convex curvature in radial direction is axisymmetric to an imaginary straight line which intersects the radial direction and which intersects the rotational axis at the sight of the light source.

3. The lighting device as set forth in claim 2, wherein the convex curvature, the index of refraction of the coupling optics, and the arrangement of the light source are coordinated so that the light beams coupled via the convex curved light coupling surface run parallel to the straight lines.

4. The lighting device as set forth in claim 1, wherein the first reflector is an indentation in the first side of the optical guide and has the shape of a truncated cone which tapers in the direction of the second side of the optical guide.

5. The lighting device as set forth in claim 1, wherein the cross-section profile is curved such and a light emitting diode is correspondingly arranged such that the light coupled over the cross section is oriented in parallel and is parallel to the straight line.

6. The lighting device as set forth in claim 1, wherein the coupling surface is an indentation in a projection protruding from the second side.

7. The lighting device as set forth in claim 6, wherein the projection has the shape of a truncated cone that propagates in the direction of the second side.

8. The lighting device as set forth in claim 1, wherein the coupling surface is an indentation in the second side and has a first subarea with a convex curvature in radial direction which is axisymmetric to an imaginary straight line which intersects the radial direction and which intersects the rotational axis at the site of the light source and has a second subarea with a convex curvature in radial direction which is axisymmetric to the rotational axis, and wherein the first reflector has a first region that is in the shape of a truncated cone and is illuminated over the first subarea, and has a second region that is conical and is illuminated by the light that is coupled over the second subarea.

9. The lighting device as set forth in claim 1, wherein a thickness of the optical guide outside of the projection or outside of the convex curved light coupling surface is not less than twice the depth of the deflection reflector.

10. The lighting device as set forth in claim 1, wherein the coupling optics has a roof edge reflector.

11. The lighting device as set forth in claim 1, wherein a thickness of the optical guide defined by one of outside the projection and outside of the convex curved light coupling surface is not less than the depth of the deflection reflector.

12. The lighting device as set forth in claim 1, wherein the coupling optics and a transport and deflecting optics are separate components joined together to an optical guide.

13. The lighting as set forth in claim 1, wherein the coupling optics and a transport and deflecting optics are components of a single-piece contiguous component.

14. The lighting device as set forth in claim 1, wherein the decoupling optics has a light exit surface and is set up to align in parallel light beams radially directed away from the rotational axis over an angular width of 180° and direct them uniformly distributed onto the light exit surface.

15. The lighting device as set forth in claim 1, wherein the decoupling optics has a light exit surface and is set up to align in parallel light beams radially directed away from the rotational axis over an angular width of 360° and direct them uniformly distributed onto the light exit surface.
